(19) United States
(12) Patent Application Publication
(10) Pub. No.: US 2026/0190006 A1
(43) Pub. Date: Jul. 2, 2026

(54) TECHNOLOGIES FOR NETWORK ENERGY SAVING CONDITIONAL HANDOVERS

(71) Applicant: Apple Inc., Cupertino, CA (US)

(72) Inventors: Peng Cheng, Beijing (CN); Haijing Hu, Los Gatos, CA (US); Dan Wu, Beijing (CN); Dawei Zhang, Saratoga, CA (US); Jie Cui, San Jose, CA (US); Naveen Kumar R. Palle Venkata, San Diego, CA (US); Fangli Xu, Beijing (CN)

(73) Assignee: Apple Inc., Cupertino, CA (US)

(21) Appl. No.: 18/862,492

(22) PCT Filed: Nov. 2, 2023
(86) PCT No.: PCT/CN2023/129383

§ 371 Date: Nov. 1, 2024

(51) Int. Cl. H04W 36/36; H04W 36/00; H04W 36/22; H04W 36/30; H04W 52/02

(52) U.S. Cl. CPC H04W 36/362; H04W 36/0072; H04W 36/22; H04W 36/304; H04W 52/0206

(57) ABSTRACT

The present application relates to devices and components, including apparatus, systems, and methods for network energy saving conditional handovers.

### TECHNICAL FIELD

This application generally relates to cellular communication networks and, in particular, to technologies for network energy saving conditional handovers.

### BACKGROUND

Wireless mobile communication technology uses various standards and protocols to transmit data between a base station and a wireless communication device. Wireless communication system standards and protocols can include, but are not limited to, the 3rd Generation Partnership Project (3GPP) long term evolution (LTE); 5th Generation (5G) 3GPP New Radio (NR); and technologies beyond 5G. In 5G wireless radio access networks (RANs), the base station may include an RAN node such as a 5G node, NR node or next-generation node B (gNB), which communicate with a wireless communication device, also known as user equipment (UE).

### BRIEF DESCRIPTION OF THE DRAWINGS

FIG. 1 illustrates a network environment in accordance with some embodiments.

FIG. 2 illustrates downlink control information in accordance with some embodiments.

FIG. 3 illustrates downlink control information in accordance with some embodiments.

FIG. 4 illustrates downlink control information and radio resource control configurations in accordance with some embodiments.

FIG. 5 illustrates a monitoring configuration in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

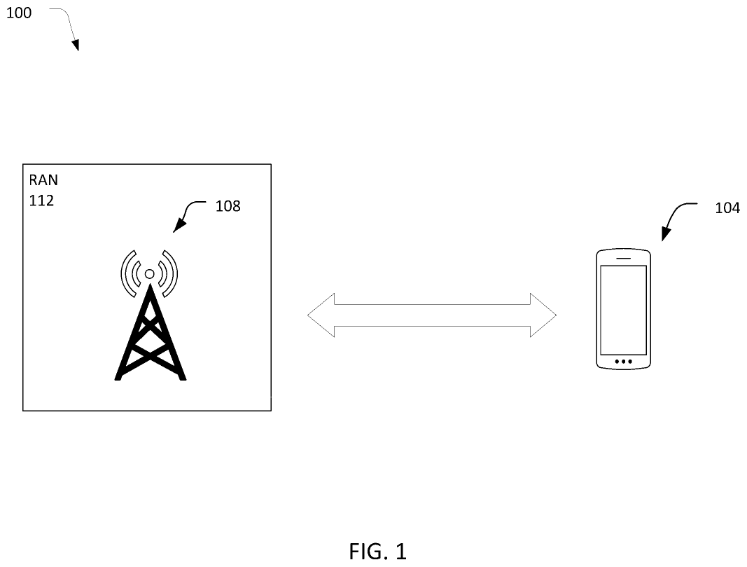

FIG. 1 illustrates a network environment 100 in accordance with some embodiments. The network environment 100 may include a UE 104 coupled with a base station (BS) 108 of a radio access network (RAN) 112 that provides one or more serving cells. In some embodiments, the BS 108 is a gNB that provides one or more 3GPP NR cells. The air interface over which the UE 104 and the BS 108 communicate may be compatible with 3GPP technical specifications (TSs), such as those that define 5G NR or later system standards (e.g., Sixth Generation (6G) standards). While the RAN 112 is shown with one base station, base station 108, it will be understood that the RAN 112 may include a number of base stations, or other access nodes, that provide services to various UEs through serving cells.

In some embodiments, the base station 108 may be one of a plurality of base stations that provide service to the UE 104 through a dual connectivity (DC) operation. The base stations may be coupled with each other via an X2 interface over an ideal or non-ideal backhaul. The base stations may include a master node (MN) to provide a control plane connection to a core network. The MN may be associated with the group of serving cells referred to as a master cell group (MCG), which includes a primary cell (SpCell) and optionally one or more secondary cells (SCells) in a carrier aggregation (CA) deployment. The SpCell of the MCG may also be referred to as a primary serving cell (PCell). The base stations may further include a secondary node (SN) that may not have a control plane connection to the core network. The SN may be used to provide additional resources to the UE 104. The SN may be associated with a group of serving cells referred to as a secondary cell group (SCG), which includes an SpCell and one or more SCells in a CA deployment. The SpCell of the SCG may also be referred to as a primary secondary serving cell (PSCell).

In some embodiments, the RAN 112 may provide a CA deployment without DC operation, in which one or more base stations provide a PCell and one or more SCells.

In some embodiments, the network may utilize a conditional handover (CHO) to improve mobility robustness and reliability. This may involve the base station 108 configuring the UE 104 with handover assistance information with respect to one or more candidate cells, and providing the one or more candidate cells with information about the UE 104. The UE 104 may then monitor link qualities for various handover conditions and execute the stored “handover” command if/when the condition(s) become true. If more than one candidate cell satisfies the conditions, the UE 104 may select the cell for which it performs the handover.

In some embodiments, the configured handover conditions may include A3 or A5 events. An A3 event may refer to the serving cell being a number of decibels (dB) worse than a target cell. An A5 event may refer to the serving cell being worse than a first threshold and the target cell being better than a second threshold. The signal metrics for measuring the serving/target cell may be one or more of reference signal receive power (RSRP), reference signal receive quality (RSRQ), or signal-to-interference-and-noise ratio (SINR). The thresholds/number of decibels may be configured by the handover assistance information, another configuration message, or predefined by a 3GPP TS.

A CHO may only be supported for a UE's PCell or PSCell. CHO may not be supported for a UE's SCell.

To enable CHOs with respect to non-terrestrial networks (NTNs), an additional handover condition, an A4 event, was introduced and new conditional trigger conditions related to location and time were defined. An A4 event may refer to the neighbor cell becoming between than a predefined threshold. Except as otherwise described herein, a CHO procedure may be similar to that described in Section 9.2.3.4 of 3GPP TS 38.300 v17.6.0 (2023-09).

In some instances, a serving cell may be capable of entering a network energy saving (NES) mode in order to save power. CHO procedures may be enhanced to address the case in which a source/target cell is in an NES mode. This may allow, for example, an NES UE to apply a relaxed CHO condition from a fixed time when the source cell enters NES mode. This may be beneficial with respect to two cases. In a first case, a source cell entering NES mode may plan to turn off some or all of its services. In this case, the source cell may not be able to adequately serve the UE 104 after it switches to the NES mode. In a second case, a source cell entering NES mode may plan to activate a cell discontinuous transmit (DTX)/discontinuous receive (DRX) configuration with a long non-active duration. In this case, a quality of service (QoS) of the UE 104 may be degraded in source cell.

In some embodiments, the RAN 112 may transmit downlink control information (DCI) to provide an indication that a serving cell is entering NES mode and the UE 104 is to trigger CHO enhancement of NES (for example, use relaxed CHO conditions). This indication may be referred to as an NES CHO indication. Transmission of DCI with the NES CHO indication may also be referred to as layer 1 (L1) trigger signaling to indicate a serving cell is entering NES mode.

In some embodiments, the DCI used to transmit the NES CHO indication may be the same DCI that is used to indicate a cell DTX/DRX configuration is activated or deactivated for a serving cell. The DCI may be a group-common DCI format 2_X, where X is an integer, that is applicable to a plurality of UEs. In some embodiments, the DCI format 2_X may be DCI format 2_9 transmitted with a cyclic redundancy check (CRC) scrambled by an NES-radio network temporary identifier (RNTI)

Embodiments of the present disclosure provide details of the DCI design that may be used to signal the NES CHO indication and details of UE operation upon receiving the information. Some embodiments describe the NES CHO bit being applied per serving cell and others describe the NES CHO bit being applied per cell group. Further embodiments address difficulties of signaling an NES CHO indication for a serving cell in a group-common DCI, when application of NES CHO is dependent on whether the serving cell is a UE's PCell, PSCell, or SCell. As discussed above, CHO is only applicable to a UE's PCell or PSCell, not a UE's SCell. However, a particular serving cell may be a PCell for a first UE and an SCell for a second UE. Thus, embodiments describe how an NES CHO indication is to be interpreted by various UEs consistent with their own serving cell configurations.

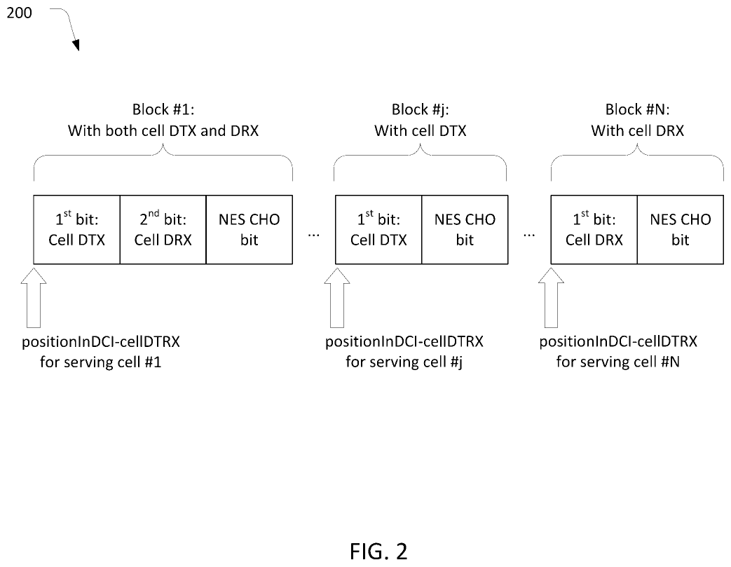

FIG. 2 illustrates a DCI 200 in accordance with some embodiments. The DCI 200 represents a first DCI signaling aspect in which a one-bit NES CHO indication is provided within one DCI block with the cell DTX/DRX indication. This may be done without having to introduce a new positionInDCI parameter that is dedicated to the NES CHO indication.

The DCI 200 may include one or more indications for a plurality of blocks (for example, N blocks). Each block may correspond to a serving cell. For example, the DCI 200 may include indications for block #1,block #j, and block #N. The starting position of each block may be indicated by a parameter positionInDCI-cellDTRX that is provided by higher layers for the UE 104. For example, the base station 108 may transmit, via radio resource control (RRC) signaling, a cell group configuration that includes a serving cell configuration for various serving cells, e.g., a PCell, a PSCell, or an SCell. The serving cell configuration may include a positionInDCI-cellDTRX parameter that the UE 104 uses to determine which indications in the DCI correspond to that particular serving cell.

Each block may include a cell DTX/DRX indication and an NES CHO indication. The cell DTX/DRX indication may indicate whether a configured cell DTX/DRX is activated or deactivated. The cell DTX/DRX indication may be two bits if both cell DTX and cell DRX are configured for the corresponding serving cell, with the most significant bit (MSB) corresponding to the cell DTX configuration and the least significant bit (LSB) corresponding to cell DRX configuration. If either cell DTX or cell DRX is configured for a cell, but not both, the cell DTX/DRX indication may include one bit.

As shown, serving cell #1may have both cell DTX and cell DRX configured, thus, its cell DTX/DRX indication includes two bits. Serving cell #j may only include a cell DTX configuration, thus, its cell DTX/DRX indication includes one bit to activate/deactivate the cell DTX configuration. Serving cell #N may only include a cell DRX configuration, thus, its cell DTX/DRX indication includes one bit to activate/deactivate the cell DRX configuration.

The NES CHO indication may be provided by one bit that follows the cell DTX/DRX bit(s). The NES CHO bit may be set to ‘1’ to indicate the corresponding cell is entering NES mode. The NES CHO bit may be set to ‘0’ to indicate the corresponding cell is not entering NES mode. Alternative bit settings may be used.

To accommodate the DCI signaling concepts embodied by DCI 200, section 7.3.1.3.10 of 3GPP TS 38.212 v18.0.0 (2023-09) may be modified by removing the struck-through text and adding the underlined text as follows:
DCI format 2_9 is used for activating or de-activating the cell DTX/DRX configuration of one or multiple serving cells or notifying the serving cell is entering NES mode to trigger CHO enhancement of NES for one or more UEs.
The following information is transmitted by means of the DCI format 2_9 with CRC scrambled by NES-RNTI:
   block number 1, block number 2, . . . , block number N
   where the starting position of a block is determined by the parameter positionInDCI-cellDTRX provided by higher layers for the UE.
If the UE is configured with higher layer parameter cellDTRX-RNTI and dci-Format2-9, one or more blocks are configured for the UE by higher layers, with the following field defined for each block:
   Cell DTX/DRX indication-0 bit if UE does not support Cell DTX/DRX operation triggered by DCI format 2_9 or UE is configured with neither cellDTXConfig nor cellDRXConfig; 2 bits if UE is configured with both cellDTXConfig and cellDRXConfig for this serving cell, with the MSB corresponding to cell DTX configuration and the LSB corresponding to cell DRX configuration; otherwise 1 bit;
   NES CHO indication-1 bit if NES CHO is configured in this serving cell.
The size of DCI format 2_9 is indicated by the higher layer parameter sizeDCI-2-9.

To accommodate the DCI signaling concepts embodied by DCI 200, section 11.5 of 3GPP TS 38.213 v18.0.0 (2023-09) may be modified by adding the underlined text as follows:
A UE configured for operation on a serving cell according to one or both of a cell DTX operation by cellDTXConfig and a cell DRX operation by cellDRXConfig for the serving cell [11, TS 38.331], can be additionally provided by dci-Format2-9 a Type3-PDCCH CSS set to monitor PDCCH for detection of DCI format 2_9 as described in clause 10.1, and a location in DCI format 2_9 by position-inDCI-NES of a cell DTX/DRX indicator field for the serving cell, if UE supports cell DTX and/or cell DRX triggered by DCI format 2_9.

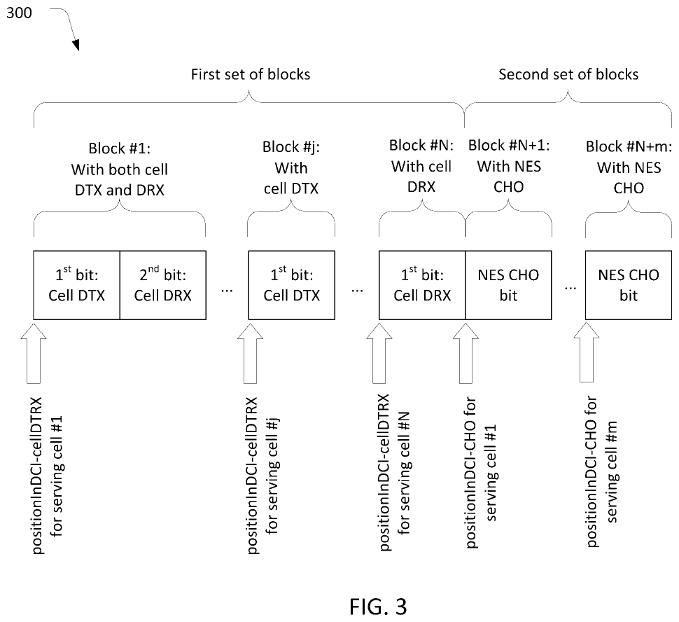

FIG. 3 illustrates a DCI 300 in accordance with some embodiments. The DCI 300 represents a second DCI signaling aspect in which a network may signal a new positionInDCI parameter that is dedicated to the NES CHO indication.

DCI 300 may include a first set of blocks (for example, block #1-block #N) that provide cell DTX/DRX indications for a corresponding set of serving cells (for example, serving cell #1-serving cell #N). The starting position of each block of the first set may be indicated by a parameter positionInDCI-cellDTRX that is provided by higher layers for the UE 104, similar to that described above with respect to DCI 200.

DCI 300 may also include a second set of blocks (for examples, block #N+1-block #N+m) that provides NES CHO indications. The second set of blocks may start after the last block of the first set of blocks. Each block of the second set may correspond to a serving cell configured with NES CHO. The number of blocks in the second set may be equal to or different from (for example, smaller than) the number of blocks in the first set. As shown, the second set of block may include block #N+1 with an NES CHO indication for serving cell #1, . . . , block #N+m with an NES CHO indication for serving cell #m.

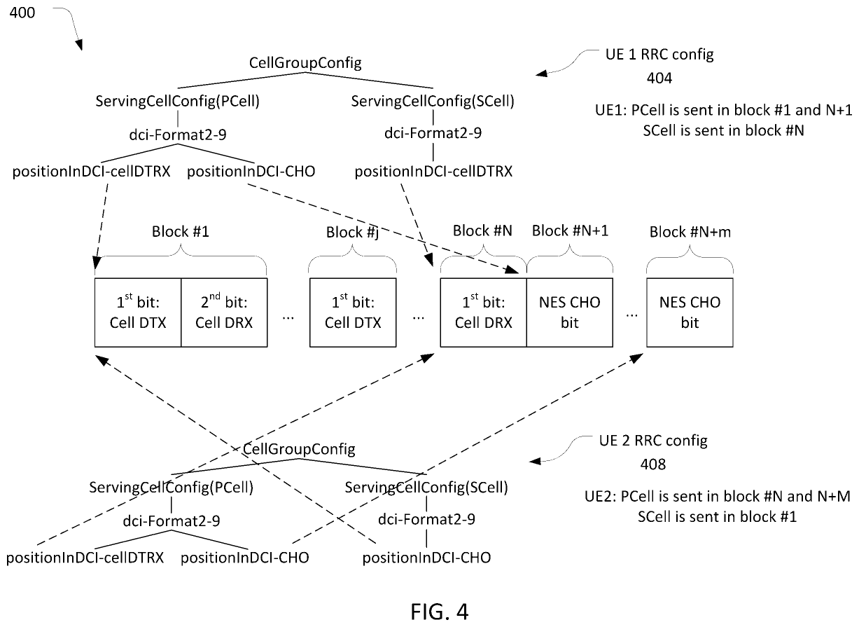

The starting position of each of the blocks in the second set of blocks may be determined by a positionInDCI-CHO parameters that are provided by higher layers to the UEs, for example, by RRC signaling. For one UE, the network may only configure positionInDCI-CHO in the UE's configuration (dci-Format2-9) of its PCell or PSCell. Some examples are shown in more detail in FIG. 4.

To accommodate the DCI signaling concepts embodied by DCI 200, section 7.3.1.3.10 of 3GPP TS 38.212 v18.0.0 (2023-09) may be modified by removing the struck-through text and adding the underlined text as follows:
DCI format 2_9 is used for activating or de-activating the cell DTX/DRX configuration of one or multiple serving cells or notifying the serving cell is entering NES mode to trigger CHO enhancement of NES for one or more UEs.
The following information is transmitted by means of the DCI format 2_9 with CRC scrambled by NES-RNTI:
   block number 1, block number 2, . . . , block number N
   where the starting position of a block is determined by the parameter positionInDCI-cellDTRX or positionInDCI-CHO provided by higher layers for the UE.
If the UE is configured with higher layer parameter cellDTXR-RNTI, dci-Format2-9, and positionInDCI-cellDTRX, one or more blocks are configured for the UE by higher layers, with the following field defined for each block:
   Cell DTX/DRX indication-2 bits if both cellDTXconfig and cellDRXconfig are configured in this serving cell, with the MSB corresponding to cell DTX configuration and the LSB corresponding to cell DRX configuration; otherwise 1 bit;
If the UE is configured with higher layer parameter cellDTRX-RNTI, dci-Format2-9 and positionInDCI-CHO, one block is configured for the UE by higher layers, with the following field defined for the block:
   NES CHO indication-1 bit if NES CHO is configured in this serving cell.
The size of DCI format 2_9 is indicated by the higher layer parameter sizeDCI-2-9.

In some embodiments, RRC parameters may be changed to accommodate the NES CHO configuration. For example, cellDTRX-DCI-config may be changed to cellES-DCI-config and it may include the configuration for new DCI format 2_9 for activation/deactivation of cell DTX/DRX configuration of one or multiple serving cells, or notifying the serving cell is entering NES mode to trigger CHO enhancement of NES. Similarly, cellDTRX-RNTI may be changed to cellES-RNTI and it may be used to configure the RNTI value for scrambling CRC of DCI format 2_9 for activating and/or deactivating Cell DTX/DRX, or notifying the serving cell is entering NES mode to trigger CHO enhancement of NES.

FIG. 4 shows the DCI 300 along with specific RRC configurations in accordance with some embodiments.

A first UE, UE 1, may be configured with serving cell #1 as its PCell and serving cell #N as its SCell. The base station 108 may use RRC signaling to provide the UE 1 with UE 1 RRC configuration 404. The UE 1 RRC configuration 404 may include a cell group configuration (CellGroupConfig) information element (IE) that includes a serving cell configuration for its PCell (ServingCellConfig (PCell)) and a serving cell configuration for its SCell (ServingCellConfig (SCell)). The ServingCellConfig (PCell) IE may include two positionInDCI parameters. The first one, positionInDCI-cellDTRX, may indicate a starting position of the cell DTX/DRX indication, for the PCell of UE 1, within the DCI 300. The second one, positionInDCI-CHO, may indicate a starting position of the NES CHO indication, for the PCell of UE 1, within the DCI 300. In this example, the NES CHO indication of block #N may be associated with the PCell of UE1. The ServingCellConfig (SCell) IE may only include one positionInDCI parameter, positionInDCI-cellDTRX, to indicate a starting position of the cell DTX/DRX indication, for the SCell of UE 1, within the DCI 300.

A second UE, UE 2, may be configured with serving cell #N as its PCell and serving cell #1 as its SCell. The base station 108 may use RRC signaling to provide the UE 2 with UE 2 RRC configuration 408. The UE 2 RRC configuration 408 may include a cell group configuration (CellGroupConfig) IE that includes a serving cell configuration for its PCell (ServingCellConfig (PCell)) and a serving cell configuration for its SCell (ServingCellConfig (SCell)). The ServingCellConfig (PCell) IE may include two positionInDCI parameters. The first one, positionInDCI-cellDTRX, may indicate a starting position of the cell DTX/DRX indication, for the PCell of UE 2, within the DCI 300. The second one, positionInDCI-CHO, may indicate a starting position of the NES CHO indication, for the PCell of UE 2, within the DCI 300. In this example, the NES CHO indication of block #N+m may be associated with the PCell of UE2. The ServingCellConfig (SCell) IE may only include one positionInDCI parameter, positionInDCI-cellDTRX, to indicate a starting position of the cell DTX/DRX indication, for the SCell of UE 2, within the DCI 300.

UE behavior upon receiving the NES CHO indications, through DCI 200 or 300, for example, may be defined in accordance with one or more of the following options.

In a first option, after the UE 104 receives an NES CHO bit, the UE 104 may identify which serving cell enters NES mode. If the serving cell entering NES mode is a PCell or PSCell of the UE 104, the UE 104 may trigger CHO enhancement for NES. This may include the UE 104 performing an NES CHO procedure for the serving cell by using relaxed CHO conditions as described elsewhere herein.

If the UE 104 determines, based on an NES CHO indication, that its PCell or PSCell is not entering NES mode, the UE may perform a normal, non-NES CHO procedure for the serving cell by using normal, non-relaxed CHO conditions.

If the UE 104 determines, based on an NES CHO indication, that the serving cell entering NES mode is an SCell of the UE 104, the UE 104 may not trigger CHO enhancement for NES.

In a second option, after the UE 104 receives an NES CHO bit, the UE 104 identifies which serving cell enters the NES mode. If the serving cell entering NES mode is within an MCG of the UE 104, the UE 104 triggers CHO enhancement for NES in its PCell. This may be the case even if the serving cell entering NES mode is an SCell of the MCG, as this may reduce a quality of service (QoS) experienced by the UE 104.

If the serving cell entering the NES mode is within an SCG of the UE 104, the UE 104 triggers CHO enhancement for NES in its PSCell. This may be the case even if the serving cell entering NES mode is an SCell of the SCG, as this may reduce a QoS experienced by the UE 104.

As discussed above, CHO procedures and NES CHO procedures may be based on various Ax conditions, where “x” is an integer variable that can be, for example, 3, 4, or 5. In some embodiments, two Ax event conditions may be configured. A first Ax event condition may be associated with a normal CHO procedure while a second Ax event condition may be associated with an NES CHO procedure.

In some embodiments, the two Ax event conditions are the same type but with different thresholds. For example, both are A5 event conditions, but their a5-Threshold2 (for neighbor cell) are different. In other embodiments, the two Ax event conditions are different types. For example, the first Ax event condition is an A5 event and the second Ax event condition is an A4 event.

In some embodiments, an additional parameter may be added to configuration signaling that indicates which of the two Ax event conditions is for the NES CHO procedure. For example, an NES indication parameter (NESecondExecutionCond) may be added to an RRC parameter. For example, the underlined text may be added to conditional reconfiguration IE (CondReconfigToAddMod) of TS 38.331 v17.6.0 (2023-09) as follows:

CondReconfigToAddMod-r16 ::= SEQUENCE {

| | |
|---|---|
| condReconfigId-r16 | CondReconfigId-r16, |
| condExecutionCond-r16 | SEQUENCE (SIZE (1..2)) OF MeasId OPTIONAL, |

-- Need M

| | |
|---|---|
| condRRCReconfig-r16 | OCTET STRING (CONTAINING |

```
  RRCReconfiguration) OPTIONAL, -- Cond condReconfigAdd
  ...,
  [[
  condExecutionCondSCG-r17 OCTET STRING (CONTAINING
  CondReconfigExecCondSCG-r17) OPTIONAL -- Need M
  ]]
[[
NEScondExecutionCond-r18 INTEGER(1..2) OPTIONAL, -- Need M.
```

In some embodiments, NEScondExecutionCond is to indicate a Meas Id whose associated execution condition is applied after reception of common L1 signaling DCI 2-9. This field is present only when configuring 2 triggering events (Meas Ids) condEventA3, condEventA4 or condEventA5 for a candidate cell.

To enable the UE behavior described above with respect to option 1, the underlined text may be added to section 5.3.5.13.4 of TS 38.331 as follows:
2> if one event within condTriggerConfig is configured with NEScondExecutionCond for a target candidate cell within the stored condRRCReconfig:
   3> if the L1 trigger signaling indicates its PCell is entering NES mode and the event configured with NEScondExecutionCond is fulfilled, or
   3> if the L1 trigger signaling indicates its PCell is not entering NES mode and the other event within condTriggerConfig is fulfilled:
   4> consider the target candidate cell within the stored condRRCReconfig, associated to that condReconfigId, as a triggered cell;
   4> initiate the conditional reconfiguration execution, as specified in 5.3.5.13.5.

To enable the UE behavior described above with respect to option 2, the underlined text may be added to section 5.3.5.13.4 of TS 38.331 as follows:
2> if one event within condTriggerConfig is configured with NEScondExecutionCond for a target candidate cell within the stored condRRCReconfig:
   3> if the L1 trigger signaling indicates one serving cell of its MCG is entering NES mode and the event configured with NEScondExecutionCond is fulfilled, or
   3> if the L1 trigger signaling indicates one serving cell of its SCG is entering NES mode and the event configured with NEScondExecutionCond is fulfilled, or
   3> if the L1 trigger signaling indicates none of serving cell is entering NES mode and the other event within condTriggerConfig is fulfilled:
      4> consider the target candidate cell within the stored condRRCReconfig, associated to that condReconfigId, as a triggered cell;
      4> initiate the conditional reconfiguration execution, as specified in 5.3.5.13.5.

In some embodiments, in order to restrict power consumption associated with the UE 104 actively monitoring for the DCI for a large period of time, the network may configure a monitoring window. The monitoring window may be configured based on cell DTX/DRX configurations.

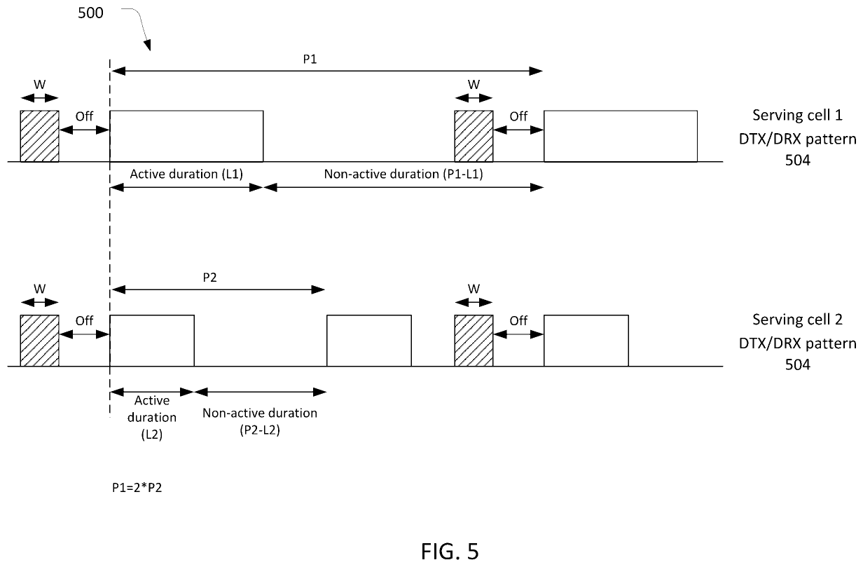

FIG. 5 illustrates a monitoring configuration 500 in accordance with some embodiments.

A cell DTX/DRX configuration may be provided per serving cell. In some embodiments, to limit complexity, the configuration may be restricted such that a maximum of two cell DTX/DRX patterns can be configured per MAC entity, and the two configured patterns are aligned. Alignment of the two configured patterns may be provided with the start and slot offset being in common for the two patterns and one periodicity being an integer multiple of the other.

With reference to the monitoring configuration 500, the UE 104 may be configured with a first DTX/DRX pattern for serving cell 1 (serving cell 1 DTX/DRX pattern) and a second DTX/DRX pattern for serving cell 2 (serving cell 2 DTX/DRX pattern). The serving cell 1 DTX/DRX pattern may include a period (P1), an active duration (L1), and an inactive duration (P1-L1). The serving cell 2 DTX/DRX pattern may include a period (P2), an active duration (L2), and a non-active duration (P2-L2).

To ensure alignment between the two patterns, P1 may be an integer multiple of P2 (for example, P1=n*P2, where n=2 as shown in FIG. 5); and the start and slot offsets of the two patterns may be the same.

The network (for example, base station 108) may configure the UE 104 with a monitoring window, shown in cross hatching in FIG. 5, to monitor DCI (for example, DCI format 2_9). The monitoring window may have a length of W slots.

The network may configure the monitoring window with a slot offset (Off) and a period based on a maximum cell DTX/DRX cycle. The maximum cell DTX/DRX cycle may be configured as an N integer multiple of: a maximum cycle of the two configured cell DTX/DRX patterns (if two are configured) or the cycle of the configured cell DTX/DRX pattern (if only 1 is configured); or a maximum cycle of all cell DTX/DRX patterns (for example, the two DTX/DRX patterns that may be configured to a UE for all serving cells) and all UE connected-mode DRX (CDRX) patterns.

The slot offset (Off) may configure a slot number between an end time of the monitoring window and a starting time of the active duration of the cell DTX/DRX with the maximum cycle. Thus, there may be no monitoring windows in the active duration(s) of the DTX/DRX pattern with the smaller periodicity that occurs between the active durations of the DTX/DRX pattern with the larger periodicity. As shown, the slot offset may be configured with respect to the starting time of the active duration of the serving cell 1 DTX/DRX pattern as it has the larger periodicity. There may be no monitoring window prior to the second active duration of the serving cell 2 DTX/DRX pattern.

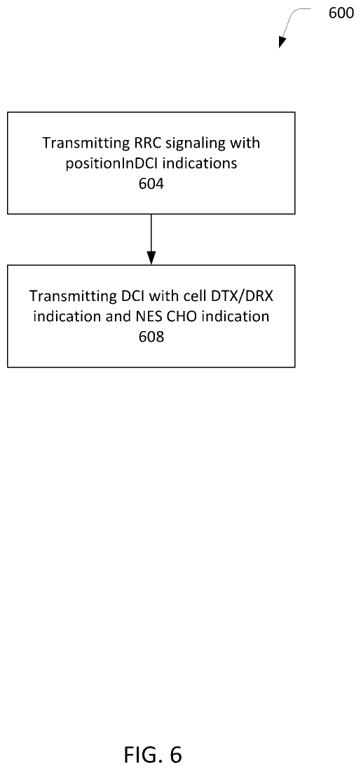

FIG. 6 illustrates an operation flow/algorithmic structure 600 in accordance with some embodiments. The operation flow/algorithmic structure 600 may be performed or implemented by a network, for example, base station 108, base station 900, or components thereof, for example, processors 904.

The operation flow/algorithmic structure 600 may include, at 604, transmitting RRC signaling with one or more position-in-DCI (positionInDCI) indications. The positionInDCI indications may be transmitted in a serving cell configuration to configure a UE with various serving cells (e.g., PCell, PSCell, or SCell) as discussed elsewhere herein.

The operation flow/algorithmic structure 600 may further include, at 608, transmitting DCI with cell DTX/DRX indication and NES CHO indication. The cell DTX/DRX indication may indicate whether a DTX/DRX configuration is activated or deactivated. The cell DTX/DRX indication may include one or two bits. The NES CHO indication may include one bit to indicate whether the serving cell is entering an NES mode.

In some embodiments, the cell DTX/DRX indication and the NES CHO indication are in one block. The one block may be indicated by one positionInDCI indication transmitted in the RRC signaling at 604. The NES CHO indication may immediately follow the cell DTX/DRX indication.

In some embodiments, the cell DTX/DRX indication and the NES CHO indication are in different blocks. For example, the DTX/DRX indication may be in a first block indicated by a first positionInDCI indication transmitted in the RRC signaling at 604 and the NES CHO indication may be in a second block indicated by a second positionInDCI indication transmitted in the RRC signaling at 604. One or more blocks may be in between the first and the second blocks.

In some embodiments, the DCI may be group common DCI having DCI format 2_9 and may include indications for a plurality of serving cells configured in the network.

In some embodiments, the RRC signaling may be used by the network to configure a plurality of event conditions. The RRC signaling may further include an NES indication to identify which of the plurality of event conditions is to be used to trigger an NES CHO procedure. For example, consider that two event conditions are configured. A first event condition may be associated with a first type and a first threshold and a second event condition may be associated with a second type and a second threshold. The first type may be equal to the second type while the first threshold is different from the second threshold; the first type may be different from the second type while the first threshold is equal to (or different from) the second threshold. The NES indication may indicate the first (or second) event condition is to be used to trigger an NES CHO procedure, while the other event condition is to be used to trigger a non-NES, or normal CHO procedure.

In some embodiments, the RRC signaling may be used by the network to provide a window a window configuration to indicate a window in which the UE is to monitor for the DCI. The window configuration may include a slot offset to provide a number of slots between an end of the window and a start of an active duration of a cell DTX/DRX pattern. The window may be configured with a period equal to N*cellDTX/DRX, where N is an integer and cellDTX/DRX is: a largest value of one or more cell DTX/DRX cycles of the serving cell; or a largest value of one or more cell DTX/DRX cycles of the serving cell and a connected-mode DRX (CDRX) cycle of the UE.

It may be noted that the RRC signaling that conveys the various parameters described herein may include one or more RRC messages that may be sent together or at different times. For example, the positionInDCI parameters may be sent in a first RRC message, configuration information of the event conditions may be sent in a second RRC message, and the window configuration may be sent in a third RRC message.

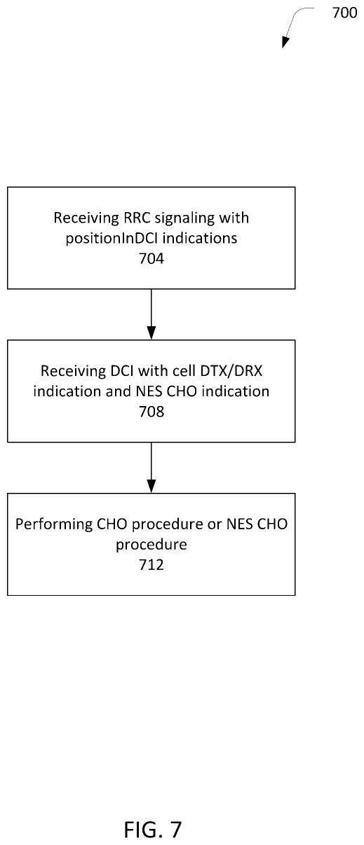

FIG. 7 illustrates an operation flow/algorithmic structure 700 in accordance with some embodiments. The operation flow/algorithmic structure 700 may be performed or implemented by a UE, for example, UE 104, UE 800, or components thereof, for example, processors 804.

The operation flow/algorithmic structure 700 may include, at 704, receiving RRC signaling with one or more position-in-DCI (positionInDCI) indications. The positionInDCI indications may be transmitted in a serving cell configuration to configure the UE with various serving cells (e.g., PCell, PSCell, or SCell) as discussed elsewhere herein.

The operation flow/algorithmic structure 700 may further include, at 708, receiving DCI with cell DTX/DRX indication and NES CHO indication. The cell DTX/DRX indication may indicate whether a DTX/DRX configuration is activated or deactivated. The cell DTX/DRX indication may include one or two bits. The NES CHO indication may include one bit to indicate whether the serving cell is entering an NES mode.

In some embodiments, the cell DTX/DRX indication and the NES CHO indication are in one block. The one block may be indicated by one positionInDCI indication received in the RRC signaling at 704. The NES CHO indication may immediately follow the cell DTX/DRX indication.

In some embodiments, the cell DTX/DRX indication and the NES CHO indication are in different blocks. For example, the DTX/DRX indication may be in a first block indicated by a first positionInDCI indication received in the RRC signaling at 704 and the NES CHO indication may be in a second block indicated by a second positionInDCI indication received in the RRC signaling at 704. One or more blocks may be in between the first and the second blocks.

In some embodiments, the DCI may be group common DCI having DCI format 2_9 and may include indications for a plurality of serving cells configured in the network.

In some embodiments, the RRC signaling may be used by the network to configure a plurality of event conditions. The RRC signaling may further include an NES indication to identify which of the plurality of event conditions is to be used to trigger an NES CHO procedure. For example, consider that two event conditions are configured. A first event condition may be associated with a first type and a first threshold and a second event condition may be associated with a second type and a second threshold. The first type may be equal to the second type while the first threshold is different from the second threshold; the first type may be different from the second type while the first threshold is equal to (or different from) the second threshold. The NES indication may indicate the first (or second) event condition is to be used to trigger an NES CHO procedure, while the other event condition is to be used to trigger a non-NES, or normal CHO procedure.

In some embodiments, the RRC signaling may be used by the network to provide a window a window configuration to indicate a window in which the UE is to monitor for the DCI. The window configuration may include a slot offset to provide a number of slots between an end of the window and a start of an active duration of a cell DTX/DRX pattern. The window may be configured with a period equal to N*cellDTX/DRX, where N is an integer and cellDTX/DRX is: a largest value of one or more cell DTX/DRX cycles of the serving cell; or a largest value of one or more cell DTX/DRX cycles of the serving cell and a connected-mode DRX (CDRX) cycle of the UE.

It may be noted that the RRC signaling that conveys the various parameters described herein may include one or more RRC messages that may be received together or at different times. For example, the positionInDCI parameters may be received in a first RRC message, configuration information of the event conditions may be received in a second RRC message, and the window configuration may be received in a third RRC message.

The operation flow/algorithmic structure 700 may further include, at 712, performing a CHO procedure or an NES CHO procedure. Which procedure may be performed may be based on whether the NES CHO indication indicates a serving cell is entering NES mode and a nature the serving cell itself (for example, whether it is PCell, PSCell, SCell, an MCG cell, or an SCG cell) in accordance with various embodiments.

In some embodiments, if UE determines the serving cell is a PCell or PSCell of the UE and the NES CHO indication indicates the serving cell is entering an NES mode, the UE may perform an NES CHO procedure for the serving cell.

In some embodiments, if UE determines the serving cell is an SCell of the UE and the NES CHO indication indicates the serving cell is entering an NES mode, the UE may perform a CHO procedure for a PCell or PSCell of the UE.

In some embodiments, if UE determines the serving cell is within an MCG of the UE and the NES CHO indication indicates the serving cell is entering an NES mode, the UE may perform an NES CHO procedure for the PCell of the UE based on said determining that the serving cell is within the MCG and is entering the NES mode.

In some embodiments, if UE determines the serving cell is within an SCG of the UE and the NES CHO indication indicates the serving cell is entering the NES mode, the UE may perform an NES CHO procedure for a PSCell of the UE based on said determining that the serving cell is within the SCG and is entering the NES mode.

In some embodiments, if UE determines the NES CHO indication indicates the serving cell is entering the NES mode and an event condition, indicated as associated with NES by an NES indication, is fulfilled, the UE may perform an NES CHO procedure based on said determining that the serving cell is entering the NES mode and said determining that the event condition is fulfilled. In some embodiments, if the serving cell is PCell of the UE, the NES CHO procedure may be performed for the PCell. In some embodiments, if the serving cell is in an MCG, the NES CHO procedure may be performed for a PCell of the UE. In some embodiments, if the serving cell is in an SCG, the NES CHO procedure may be performed for a PSCell of the UE.

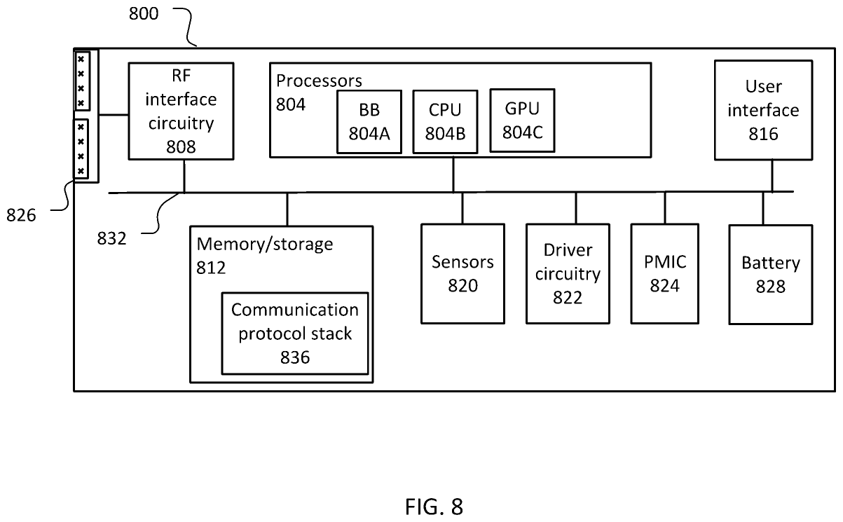

FIG. 8 illustrates a UE 800 in accordance with some embodiments. The UE 800 may be similar to and substantially interchangeable with UE 84 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry, or processor circuitry that executes or otherwise operates computer-executable instructions, such as program code, software modules, or functional processes from memory/storage 812 to cause the UE 800 to perform operations as described herein.

The processors 804 may perform operations associated with receiving RRC signaling and DCI and performing NES CHO procedures accordingly as described herein. For example, the processors 804 may perform the operation flow/algorithmic structure 700 or some other operation described herein.

In some embodiments, the baseband processor circuitry 804A may access a communication protocol stack 836 in the memory/storage 812 to communicate over a 3GPP-compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The memory/storage 812 may include one or more non-transitory, computer-readable media that includes instructions (for example, the communication protocol stack 836) that may be executed by one or more of the processors 804 to cause the UE 800 to perform various operations described herein. The memory/storage 812 includes any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processor 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 826.

In various embodiments, the RF interface circuitry 808 may be configured to transmit/receive signals in a manner compatible with NR access technologies.

The antenna 826 may include antenna elements to convert electrical signals into radio waves to travel through the air and to convert received radio waves into electrical signals. The antenna elements may be arranged into one or more antenna panels. The antenna 826 may have antenna panels that are omnidirectional, directional, or a combination thereof to enable beamforming and multiple input, multiple output communications. The antenna 826 may include microstrip antennas, printed antennas fabricated on the surface of one or more printed circuit boards, patch antennas, or phased array antennas. The antenna 826 may have one or more panels designed for specific frequency bands, including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within or connected to the UE 800. For example, the driver circuitry 822 may include circuitry to facilitate the coupling of a universal integrated circuit card (UICC) or a universal subscriber identity module (USIM) to the UE 800. For additional examples, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage the power provided to various components of the UE 800. In particular, with respect to the processors 804, the PMIC 824 may control power-source selection, voltage scaling, battery charging, or DC-to-DC conversion.

In some embodiments, the PMIC 824 may control or otherwise be part of various power-saving mechanisms of the UE 800, including DRX, as discussed herein.

A battery 828 may power the UE 800, although in some examples, the UE 800 may be mounted and deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery.

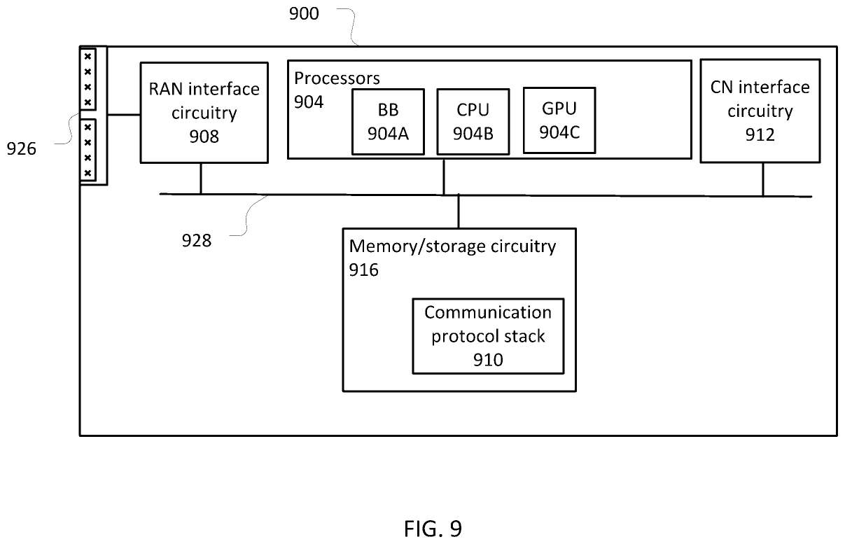

FIG. 9 illustrates a base station 900 in accordance with some embodiments. The base station 900 may be similar to and substantially interchangeable with base station 108.

The base station 900 may include processors 904, RF interface circuitry 908, core network (CN) interface circuitry 912, memory/storage circuitry 916, and antenna structure 926.

The processors 904 may perform operations associated with generating and transmitting RRC signaling and DCI as described herein. For example, the processors 904 may perform the operation flow/algorithmic structure 600 or some other operation described herein.

The components of the base station 900 may be coupled with various other components over one or more interconnects 928.

The processors 904, RF interface circuitry 908, memory/storage circuitry 916 (including communication protocol stack 910), antenna structure 926, and interconnects 928 may be similar to like-named elements shown and described with respect to FIG. 8.

The CN interface circuitry 912 may provide connectivity to a core network, for example, a 5th Generation Core network (5GC) using a 5GC-compatible network interface protocol such as carrier Ethernet protocols, or some other suitable protocol. Network connectivity may be provided to/from the base station 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the base station 900 may be coupled with transmit receive points (TRPs) using the antenna structure 926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary aspects are provided.

Example 1 includes a method to be implemented by a base station, the method comprising: transmitting radio resource control (RRC) signaling to provide one or more position-in-downlink control information (DCI) indications; and transmitting downlink control information (DCI) that includes a plurality of indications associated with the serving cell, the plurality of indications including a cell discontinuous transmit (DTX)/discontinuous receive (DRX) indication to activate or deactivate DTX or DRX for the serving cell, and a network energy saving (NES) conditional handover (CHO) indication to indicate whether the serving cell is entering an NES mode, wherein: the cell DTX/DRX indication and the NES CHO indication are in one block indicated by one position-in-DCI indication of the one or more position-in-DCI indications; or the cell DTX/DRX indication is in a first block indicated by a first position-in-DCI indication of the one or more position-in-DCI indications and the NES CHO indication is in a second block indicated by a second position-in-DCI indication of the one or more position-in-DCI indications.

Example 2 includes the method of example 1 or some other example herein, wherein the cell DTX/DRX indication and the NES CHO indication are in one block indicated by one position-in-DCI indication of the one or more position-in-DCI indications.

Example 3 includes the method of example 2 or some other example herein, wherein the one block includes one or more DTX/DRX indications that include the DTX/DRX indication and the NES CHO indication is to immediately follow the one or more DTX/DRX indications in the one block.

Example 4 includes the method of example 1 or some other example herein, wherein the cell DTX/DRX indication is in a first block indicated by a first position-in-DCI indication of the one or more position-in-DCI indications and the NES CHO indication is in a second block indicated by a second position-in-DCI indication of the one or more position-in-DCI indications.

Example 5 includes the method of example 1 or some other example herein, wherein the serving cell is a primary serving cell (PCell) or a primary secondary serving cell (PSCell) of the UE.

Example 6 includes the method of example 5 or some other example herein, wherein the RRC signaling comprises a serving cell configuration for the PCell or the PSCell, and the first and second position-in-DCI indications are in the serving cell configuration.

Example 7 includes the method of example 4 or some other example herein, wherein the DCI includes one or more blocks between the first block and the second block.

Example 2 includes the method of example 1 or some other example herein, wherein the RRC signaling is to further provide: an NES indication to identify an event condition, from a plurality of configured event conditions, that is to be used to trigger an NES CHO procedure.

Example 9 includes the method of example 8 or some other example herein, wherein: the plurality of configured event conditions include a first event condition associate with a first type and a first threshold and a second event condition associated with a second type and a second threshold; and the first type is equal to the second type and the first threshold is different from the second threshold; the first type is different from the second type and the first threshold is equal to the second threshold; or the first type is different from the second type and the first threshold is different from the second threshold.

Example 10 includes the method of example 1 or some other example herein, wherein the RRC signaling is to further provide: a window configuration to indicate a window in which the UE is to monitor for the DCI.

Example 11 includes the method of example 10 or some other example herein, wherein the window configuration includes a slot offset to provide a number of slots between an end of the window and a start of an active duration of a cell DTX/DRX pattern.

Example 12 includes the method of example 10 or 11 or some other example herein, wherein the window has a period equal to N*cellDTX/DRX, where N is an integer and cellDTX/DRX is: a largest value of one or more cell DTX/DRX cycles of the serving cell; or a largest value of one or more cell DTX/DRX cycles of the serving cell and a connected-mode DRX (CDRX) cycle of the UE.

Example 13 includes a method to be implemented by a user equipment (UE), the method comprising: receiving radio resource control (RRC) signaling to provide one or more position-in-downlink control information (DCI) indications; and receiving downlink control information (DCI) that includes a plurality of indications associated with the serving cell, the plurality of indications including a cell discontinuous transmit (DTX)/discontinuous receive (DRX) indication to activate or deactivate DTX or DRX for the serving cell, and a network energy saving (NES) conditional handover (CHO) indication to indicate whether NES CHO is configured for the serving cell, wherein: the cell DTX/DRX indication and the NES CHO indication are in one block indicated by one position-in-DCI indication of the one or more position-in-DCI indications; or the cell DTX/DRX indication is in a first block indicated by a first position-in-DCI indication of the one or more position-in-DCI indications and the NES CHO indication is in a second block indicated by a second position-in-DCI indication of the one or more position-in-DCI indications.

Example 14 includes the method of example 13 or some other example herein, wherein the serving cell is a primary serving cell (PCell) or primary secondary cell (PSCell) of the UE and the method further comprises: determining, based on the NES CHO indication, the serving cell is entering an NES mode; and performing an NES CHO procedure based on said determining that the serving cell is entering an NES mode.

Example 15 includes the method of example 13 or some other example herein, wherein the serving cell is a secondary serving cell (SCell) of the UE and the method further comprises: determining, based on the NES CHO indication, that the SCell is entering an NES mode; and performing a CHO procedure for a primary serving cell (PCell) or primary secondary cell (PSCell) of the UE.

Example 16 includes the method of example 13 or some other example herein, further comprising: determining the serving cell is within a master cell group (MCG) of the UE; determining, based on the NES CHO indication, that the serving cell is entering an NES mode; and performing an NES CHO procedure for a primary serving cell (PCell) of the UE based on said determining that the serving cell is within the MCG and is entering the NES mode.

Example 17 includes the method of example 13 or some other example herein, further comprising: determining the serving cell is within a secondary cell group (SCG) of the UE; determining, based on the NES CHO indication, that the serving cell is entering an NES mode; and performing an NES CHO procedure for a primary secondary serving cell (PSCell) of the UE based on said determining that the serving cell is within the SCG and is entering the NES mode.

Example 18 includes the method of example 13 or some other example herein, wherein the RRC signaling is to further provide an NES indication to identify an event condition, from a plurality of configured event conditions, that is to be used to trigger an NES CHO procedure, and the method further comprises: determining, based on the NES CHO indication, the serving cell is entering an NES mode; determining that the event condition is fulfilled; and performing an NES CHO procedure based on said determining that the serving cell is entering the NES mode and said determining that the event condition is fulfilled.

Example 19 includes the method of example 18 or some other example herein, wherein: the serving cell is a primary cell (PCell) of the UE and the method comprises performing the NES CHO procedure for the PCell; the serving cell is in a master cell group (MCG) and the method comprises performing the NES CHO procedure for a primary serving cell (PCell) of the UE; or the serving cell is in a secondary cell group (SCG) and the method comprises performing the NES CHO procedure for a primary secondary serving cell (PSCell) of the UE.

Example 20 includes the method of example 13 or some other example herein, wherein the RRC signaling is to further provide a window configuration to indicate a window and the method further comprises: monitoring for the DCI in the window.

Example 21 includes the method of example 20 or some other example herein, wherein the window configuration includes a slot offset to provide a number of slots between an end of the window and a start of an active duration of a cell DTX/DRX.

Example 22 includes the method of example 10 or 11 or some other example herein, wherein the window has a period equal to N*cellDTX/DRX, where N is an integer and cellDTX/DRX is: a largest value of one or more cell DTX/DRX cycles of the serving cell; or a largest value of one or more cell DTX/DRX cycles of the serving cell and a connected-mode DRX (CDRX) cycle of the UE.

Another example may include an apparatus comprising logic, modules, or circuitry to perform one or more elements of a method described in or related to any of examples 1-22 or any other method or process described herein.

Another example may include a method, technique, or process as described in or related to any of examples 1-22 or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-22, or portions thereof.

Another example includes a signal as described in or related to any of examples 1-22 or portions or parts thereof.

Another example may include a datagram, information element, packet, frame, segment, PDU, or message as described in or related to any of examples 1-22, or portions or parts thereof, or otherwise described in the present disclosure.

Another example may include a signal encoded with data as described in or related to any of examples 1-22, or portions or parts thereof, or otherwise described in the present disclosure.

Another example may include a signal encoded with a datagram, IE, packet, frame, segment, PDU, or message as described in or related to any of examples 1-22, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-22, or portions thereof.

Another example may include a computer program comprising instructions, wherein execution of the program by a processing element is to cause the processing element to carry out the method, techniques, or process as described in or related to any of examples 1-22 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Any of the above-described examples may be combined with any other example (or combination of examples) unless explicitly stated otherwise. The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-22. (canceled)

23. One or more non-transitory, computer-readable media having instructions that, when executed, cause processor circuitry to:
generate radio resource control (RRC) signaling to provide one or more position-in-downlink control information (DCI) indications; and
generate downlink control information (DCI) that includes a plurality of indications associated with a serving cell, the plurality of indications including a cell discontinuous transmit (DTX)/discontinuous receive (DRX) indication to activate or deactivate DTX or DRX for the serving cell, and a network energy saving (NES) conditional handover (CHO) indication to indicate whether the serving cell is entering an NES mode,
wherein the cell DTX/DRX indication and the NES CHO indication are in one block indicated by one position-in-DCI indication of the one or more position-in-DCI indications.

24. The one or more non-transitory, computer-readable media of claim 23, wherein the one block includes one or more DTX/DRX indications that include the DTX/DRX indication and the NES CHO indication is to immediately follow the one or more DTX/DRX indications in the one block.

25. The one or more non-transitory, computer-readable media of claim 23, wherein the serving cell is a primary serving cell (PCell) or a primary secondary serving cell (PSCell).

26. The one or more non-transitory, computer-readable media of claim 25, wherein the RRC signaling comprises a serving cell configuration for the PCell or the PSCell, and the one position-in-DCI indication is in the serving cell configuration.

27. The one or more non-transitory, computer-readable media of claim 23, wherein the RRC signaling is to further provide:
an NES indication to identify an event condition, from a plurality of configured event conditions, that is to be used to trigger an NES CHO procedure.

28. The one or more non-transitory, computer-readable media of claim 27, wherein:
the plurality of configured event conditions include a first event condition associate with a first type and a first threshold and a second event condition associated with a second type and a second threshold; and
the first type is equal to the second type and the first threshold is different from the second threshold; the first type is different from the second type and the first threshold is equal to the second threshold; or the first type is different from the second type and the first threshold is different from the second threshold.

29. The one or more non-transitory, computer-readable media of claim 23, wherein the RRC signaling is to further provide:
a window configuration to indicate a window in which a user equipment (UE) is to monitor for the DCI.

30. The one or more non-transitory, computer-readable media of claim 29, wherein the window configuration includes a slot offset to provide a number of slots between an end of the window and a start of an active duration of a cell DTX/DRX pattern.

31. The one or more non-transitory, computer-readable media of claim 29, wherein the window has a period equal to N*cellDTX/DRX, where Nis an integer and cellDTX/DRX is: a largest value of one or more cell DTX/DRX cycles of the serving cell; or a largest value of one or more cell DTX/DRX cycles of the serving cell and a connected-mode DRX (CDRX) cycle of the UE.

32. A method comprising:
receiving radio resource control (RRC) signaling to provide one or more position-in-downlink control information (DCI) indications; and
receiving downlink control information (DCI) that includes a plurality of indications associated with a serving cell, the plurality of indications including a cell discontinuous transmit (DTX)/discontinuous receive (DRX) indication to activate or deactivate DTX or DRX for the serving cell, and a network energy saving (NES) conditional handover (CHO) indication to indicate whether NES CHO is configured for the serving cell,
wherein the cell DTX/DRX indication and the NES CHO indication are in one block indicated by one position-in-DCI indication of the one or more position-in-DCI indications.

33. The method of claim 32, wherein the serving cell is a primary serving cell (PCell) or primary secondary cell (PSCell).

34. The method of claim 33, further comprising:
determining, based on the NES CHO indication, the serving cell is entering an NES mode; and
performing an NES CHO procedure based on said determining that the serving cell is entering an NES mode.

35. The method of claim 32, wherein the serving cell is a secondary serving cell (SCell) and the method further comprises:
determining, based on the NES CHO indication, that the SCell is entering an NES mode; and
performing a CHO procedure for a primary serving cell (PCell) or primary secondary cell (PSCell).

36. The method of claim 32, further comprising:
determining the serving cell is within a master cell group (MCG);
determining, based on the NES CHO indication, that the serving cell is entering an NES mode; and
performing an NES CHO procedure for a primary serving cell (PCell) based on said determining that the serving cell is within the MCG and is entering the NES mode.

37. The method of claim 32, further comprising:
determining the serving cell is within a secondary cell group (SCG);
determining, based on the NES CHO indication, that the serving cell is entering an NES mode; and
performing an NES CHO procedure for a primary secondary serving cell (PSCell) based on said determining that the serving cell is within the SCG and is entering the NES mode.

38. The method of claim 32, wherein the RRC signaling is to further provide an NES indication to identify an event condition, from a plurality of configured event conditions, that is to be used to trigger an NES CHO procedure, and the method further comprises:
determining, based on the NES CHO indication, the serving cell is entering an NES mode;
determining that the event condition is fulfilled; and
performing an NES CHO procedure based on said determining that the serving cell is entering the NES mode and said determining that the event condition is fulfilled.

39. The method of claim 38, wherein:
the serving cell is a primary cell (PCell) and the method comprises performing the NES CHO procedure for the PCell;
the serving cell is in a master cell group (MCG) and the method comprises performing the NES CHO procedure for a primary serving cell (PCell); or
the serving cell is in a secondary cell group (SCG) and the method comprises performing the NES CHO procedure for a primary secondary serving cell (PSCell).

40. An apparatus comprising:
processor circuitry to:
receive radio resource control (RRC) signaling to provide one or more position-in-downlink control information (DCI) indications; and
receive downlink control information (DCI) that includes a plurality of indications associated with the serving cell, the plurality of indications including a cell discontinuous transmit (DTX)/discontinuous receive (DRX) indication to activate or deactivate DTX or DRX for the serving cell, and a network energy saving (NES) conditional handover (CHO) indication to indicate whether NES CHO is configured for the serving cell,
wherein the cell DTX/DRX indication and the NES CHO indication are in one block indicated by one position-in-DCI indication of the one or more position-in-DCI indications; and
interface circuitry coupled with the processor circuitry to enable communication.

41. The apparatus of claim 40, wherein the RRC signaling is to further provide a window configuration to indicate a window and the processor circuitry is further to:
monitor for the DCI in the window.

42. The apparatus of claim 41, wherein the window configuration includes a slot offset to provide a number of slots between an end of the window and a start of an active duration of a cell DTX/DRX.
